(19) United States
(12) Patent Application Publication
(10) Pub. No.: US 2002/0143089 A1
(43) Pub. Date: Oct. 3, 2002

(54) Plastic sheets with improved wear resistance and methods of production

(76) Inventors: Ettore Minghetti, Florence, KY (US); Harry Cheesman, Walton, KY (US); John Eitel, Florence, KY (US); Carol Wetter, Walton, KY (US)

Correspondence Address: THORP REED & ARMSTRONG, LLP, ONE OXFORD CENTRE, 301 GRANT STREET, 14TH FLOOR, PITTSBURGH, PA, 15219-1425, US

(21) Appl. No.: 09/767,472

(22) Filed: Jan. 23, 2001

(51) Int. Cl. C08K 3/18

(52) U.S. Cl. 524/430; 524/558

(57) ABSTRACT

The present invention provides plastic sheets having a superior abrasion resistance to the sheets marketed as solid surface, by the inclusion therein of 1 phr to 70 ph of tabular alumina particles.

### FIELD OF THE INVENTION

The present invention relates in general to plastic sheets comprising an organic matrix containing pigments and/or specific inorganic fillers, and more specifically to plastic sheets having a superior wear-resistance to sheets sold as solid surface.

### BACKGROUND OF THE INVENTION

The abrasion resistance of conventional plastic sheets, even those containing some inorganic fillers, is quite limited. Examples of non-mineral filled plastic sheets are, (polymethyl methacrylate) sheets produced by the assignee of the present invention, and sold under the name of Altair® I-3 and GPA, transparent, translucent or colored. Examples of mineral-filled sheets are those known as solid surfacing materials, which are generally made from polyester or acrylic resins containing between 30 and 70% of inorganic fillers. Aluminum trihydrate is the most commonly used filler but other minerals are also used. Among the best known products of this kind are Corian® made by Dupont, Formstone® made by Avonite and Gibraltar® made by Wilsonart, International.

Typical fillers for solid surface materials are aluminum tri-hydrate, calcium carbonate and quartz/silica-based minerals. Many products contain aluminum tri-hydrate as the dominant component, in quantities from 30 to 70% weight. However, the abrasion resistance of the resulting sheet or object is poor.

Also, in sheets prepared by the casting process, there may be a tendency of the mineral fillers to settle to the bottom surface before the polymerization has progressed sufficiently to prevent such a phenomena. In general terms, the settling should be prevented or minimized, to avoid differences in composition that would cause

1) anisotropic properties,

2) the generation of internal stresses, and

3) the eventual warping of the sheet itself.

Warping is particularly detrimental because it cannot be eliminated by thermal annealing or other methods. Settling of particles can be prevented by using higher viscosity mixtures and thixotropic agents, as is practiced by those in the art.

Although several patents, notably U.S. Pat. Nos. 4,011,358; 4,927,704; 5,051,308; 5,156,882 and 5,190,807, describe coating a plastic article with a layer of material containing aluminum oxide to achieve improved abrasion resistance, the Inventors are unaware of anyone incorporating aluminum oxide into the plastic itself prior to the polymerization as described herein.

Therefore, a need exists in the art for a plastic sheet with improved wear resistance.

### SUMMARY OF THE INVENTION

The present invention provides a composition comprising a plastic having dispersed therein about 1 phr to about 70 phr of tabular alumina particles.

The present invention further provides a method of making plastic, the method comprising: combining about 1 phr to about 70 phr of tabular alumina particles with a plastic resin; and polymerizing said resin to make a plastic with improved abrasion resistance.

The present invention yet further provides a composition comprising polymethyl methacrylate having dispersed therein about 1 phr to about 70 phr of tabular alumina particles.

The present invention yet still further provides a method of making a polymethyl methacrylate article, the method comprising, combining a syrup comprising 10-35% polymethyl methacrylate polymer in methyl methacrylate monomer with about 1 to about 70 phr tabular alumina, polymerizing the syrup, and forming the polymerized syrup into said article, said article having improved abrasion resistance.

The present invention provides plastic sheets with significantly improved wear resistance. This improvement is achieved by adding aluminum oxide particles to formulations which may or may not contain other mineral fillers and, in particular to those containing aluminum tri-hydrate. If a part produced by the present invention is exposed to an abrasive process, a minimal removal of material will occur. In addition, the surface gloss may be higher for products made by the present invention after multiple abrasions than for products made with same formulation and ingredients but without aluminum oxide.

### DETAILED DESCRIPTION OF THE INVENTION

As used herein, the term “plastic” can include, but is not limited to: acrylic, polyester, polymethyl methacrylate, polycarbonate, polyvinyl chloride, acrylonitrile-butadiene-styrene, polystyrene and other polyolefins.

The term “plastic sheet” can mean sheets made by a variety of methods including, but not limited to, cell casting, continuous casting, extrusion, injection molding, pultrusion and calendering.

As used herein, the term “syrup” may refer to a composition comprising methyl methacrylate monomer and from 10-35 wt % methyl methacrylate polymer and can possibly include other ingredients such as chain transfer agents, crosslinking agents, release agents, initiators and fillers as needed and as commonly used in the art.

In addition, the plastic sheets of the present invention can possibly include a variety of fillers, including, but not limited to: powdered talc, powdered quartz, silica, minerals such as china clay, montmorillonite, and bentonite; powdered chalk; marble, limestone, zircon sand, aluminum silicate, calcium silicate, aluminum trihydrate, and clear or pigmented poly(methyl methacrylate) chips, flakes or particles.

The inventors have discovered that the addition of aluminum oxide significantly improves the abrasion resistance of plastic sheets. There are different types of aluminum oxide, with the most common form being zircon sand alumina oxide powders. The powders are sold under different names such as alumina, calcined alumina, polishing grade alumina, catalyst grade alumina, thermally reactive alumina and the like. Its presence in the formulations of the present invention significantly improves the wear resistance. This improvement of the abrasion resistance is seen in plastic compositions made with or without other added mineral fillers. The inventors' preferred form of aluminum oxide, known as tabular alumina, provides an even better performance than calcined alumina. Surprisingly, even the addition of a small quantity of tabular alumina in relation to the total content of mineral filler will bring about a significant improvement. Tabular alumina is obtained by heating the aluminum oxide at very high temperatures. A particularly preferred tabular alumina is commercially available from Aluchem, Inc. under the designation AC-99 and is a high density, fully shrunk, coarse crystalline alpha alumina that has been converted to the tabular form, by sintering calcined alumina at about 2,000° C. The tabular alumina can be incorporated into the casting mixture by traditional techniques used by those in the art of preparing sheets by casting methods.

The inventors prefer that the tabular alumina be in the form of small particles which are invisible to the eye of an observer, because such particles do not interfere with the appearance or color of the sheet and are more likely to remain homogenously distributed throughout the sheet. However, larger particle sizes may be used in this invention in mixtures with higher viscosities or with an almost paste-like consistency. The preferred particle size of the tabular alumina used in the present invention is from a few microns up to about 6 mesh depending upon the techology and process used to make the sheets. To reduce the tendency of the larger particles of tabular alumina to settle, the inventors prefer to use particles smaller than 28 mesh and more preferably smaller than 60 mesh. Tabular alumina can comprise up to about 70% of the composition depending upon the presence of other solids such as aluminum tri-hydrate (ATH) and/or colored particles. The inventors have adopted the U.S.A. Standard Sieve configuration per ASTM E11 and use sieves sold by Newark Wire & Cloth Co.

To evaluate the superior wear resistance of the products made according to the present invention, the inventors tried some existing test methods like ASTM C241-90 “Standard Test Method for Abrasion Resistance of Stone Subjected to Foot Traffic” and ASTM 0968-93 “Abrasion Resistance of Organic Coatings by Falling Abrasive”. Those tests were selected after reviewing the test methods practiced for plastic, stone and ceramic floor materials, but did not provide significant data when used on other materials because the tests were designed for a specific group of materials. Other tests were performed using a Taber® abrader, because it is a device used in several of the above-mentioned ASTM tests. Unfortunately, the results of those tests were variable and inconsistent when duplication was attempted. The inventors suspect that the particles removed by the wheels of the abrader coat the small surface of the wheels in an inconsistent manner leading to the poor reproducibility seen in the data. The inventors have concluded that because the tests listed above were designed to evaluate floor-type materials they may not properly evaluate the performance of sheet products which can be used in a variety of applications such as countertops, spas, and vertical walls in high traffic areas.

In an effort to better demonstrate the properties of the sheets made by the present invention, the Inventors devised two tests: a 50 Steel-Wool Strokes and a Weight Loss Test from abrasion of 100-grit sandpaper.

50 Steel-Wool Strokes Test

This test was performed on 8×8-inch (20.32×20.32 cm) samples. The surface was first cleaned with isopropyl alcohol and the percent gloss at 60° was read, using a gloss-meter, (Gardner, cat. No. 4525). A 4-inch (10.16 cm) long pad of new “00” steel wool, (about half an inch thick) was placed on the surface of the sample. The operator applied moderate pressure with the 3 middle fingers and moved the pad of steel wool back and forth, covering a path about 3 inches (7.62 cm) wide and 6 inches (15.24 cm) long, and completed 50 individual strokes. This test is a qualitative one because instrument readings of the changes in gloss have a degree variability, although the changes in gloss can be easily compared and rated by an observer. The extent of the variability is significantly reduced if an average of 3 readings is taken with the length of the meter body oriented perpendicular to the direction of the strokes. Two other important requirements of this test are that the same operator perform the test on reference samples and on the corresponding wear-resisting samples at the same time and that new steel-wool pads be used each time.

Weight Loss Test

This test was performed with 100 grit sandpaper using an orbital sander kept in place by a jig that allowed the sander to oscillate freely, but prevented it from moving away from the area being tested. A new disc of sandpaper, 5 inches (12.7 cm) in diameter Hookit™ DF Gold Film Discs P100 Grade (produced by the 3M Corp.) was mounted on a random orbital sander (Model 333, made by Porter Cable). The sample to be tested was cut to a size of 5⅞×5⅞ inches (14.93×14.93 cm), weighed and placed in the jig base where it could not move sideways. The orbital sander was placed on the sample and started. The orbital sander oscillated freely and operated for 15 minutes. The sandpaper left a track on the material that should not be more than 5.25 inches (13.3 cm) in diameter. The sample was cleaned from the debris and weighed to measure the weight loss. More 15-minute segments of sanding were performed and the weight loss for each period recorded unless the sanding disk wore through the sample. The test gives the actual weight loss in grams, and because it is obtained from the same type of sanding discs and test conditions, the result can be used to make quantitative comparisons of sheets made with and without added aluminum oxide.

This test was utilized on several other materials to give some indication in as to its efficiency: solid oak flooring material 0.75 in (1.91 cm) yielded 14.1 g weight loss after 15 mins.; mirror polished stainless steel plat 0.11 in. (0.28 cm) yielded 1.2 g weight loss after 15 mins. and granite solid surface sheet (acrylic based, marketed by another manufacturer) 0.5 in. (1.27 cm) yielded 11.7g after 15 mins.

The present invention will now be described for the purposes of illustration and not limitation by the following examples. In these examples, a minus (−) sign before the rating of a sieve, e.g., −325 mesh, means that the particles pass through a 325 mesh size sieve.

### Comparative Example 1

A clear transparent sheet was prepared from an acrylic syrup, as follows: methyl methacrylate and butyl acrylate monomers were partially polymerized, to a viscosity of 3.0 Poise and a polymer content of 20% by weight. Other ingredients, as known by those in the art, were added to the syrup to prepare a mixture for polymerization. Among those ingredients were a chain transfer agent, a crosslinker, a release agent and a small amount of peroxyesters as initiators. The mixture was degassed under vacuum for 20 minutes and poured into a cell which was formed by two opposing 14 inch×14 inch (35.6×35.6 cm) polished stainless steel plates, spaced to a uniform distance of about 0.125 inch (0.318 cm) by a gasket around the perimeter. After the cell was sealed, it was placed in a horizontal position in a hot water bath maintained at 180° F. for 30 minutes. The curing process was completed in an air-circulated oven at 250° F. for 20 minutes. After cooling, the cell was disassembled to obtain a glossy, smooth, void-free acrylic sheet of 0.125 inch (0.318 cm) thickness. The test results obtained from this example are listed in Table 1 together with the results from testing of the examples that follow.

### EXAMPLE 2

The procedure of Comparative Example 1 was repeated, except that 10 phr of tabular alumina particles were added to the syrup under moderate agitation after the addition of other ingredients listed in Comparative Example 1 were added, but before degassing. The tabular alumina particles, AC-12 (Aluchem, Inc.) were −325 mesh.

### Comparative Example 3

The procedure of Comparative Example 1 was repeated and 3.1 phr TiO₂-based pigment paste were added under agitation to the syrup before the other ingredients were added. The pigment paste (111 EU-52) was produced by Aristech Chemical Corp. and has a TiO₂ content of 51.9% by weight.

### EXAMPLE 4

The procedure of Comparative Example 3 was repeated except that 10 phr of the same sized tabular alumina particles as used in Example 2 were added.

### Comparative Example 5

A solid surface type sheet of uniform color was prepared following the steps of Comparative Example 1, but 60 parts of aluminum tri-hydrate (OE-431, Huber Corp.) were also added under agitation to 40 parts of syrup which contained a wetting agent.

### EXAMPLES 6 and 7

The procedure of Comparative Example 5 was followed, but an additional 10 phr of tabular alumina AC-12, −325 mesh (Aluchem Inc.) were added under agitation before the degassing step (Example 6) or 1.0 phr of the same sized tabular alumina was added (Example 7).

### Comparative Example 8

A solid-surface type sheet with a granite appearance was obtained by including both white and black particles (produced by grinding cell-cast sheets which were prepared using the procedure of Example 6). To obtain a white-colored sheet, a small quantity of TiO₂ based pigment paste was added. To obtain a black-colored sheet, a small quantity of carbon black-based pigment was added. Those colored sheets were individually ground to obtain black and white particles which were then sifted through a 35 mesh sieve, i.e., −35 mesh. Equal amounts of those white and black particles were added under agitation to a mixture of syrup, methyl methacrylate, aluminum tri-hydrate OE-431 and a small amount of thickening agent. The amount of particles constituted 11.8% weight of the total mix. After degassing, catalyst addition and curing in a water bath, a sheet with a granite appearance was obtained.

### EXAMPLES 9 and 10

The procedure of Comparative Example 8 was used to prepare a sheet sample, in which 10.0 phr of tabular alumina AC-99, −100 mesh particles (Aluchem Inc.) were also added to the mixture of syrup, methyl methacrylate, OE-431 and thickening agent (Example 9) or 1.0 phr of AC-99, −100 mesh particles was used (Example 10).

### Comparative Example 11 and Example 12

Sample sheets were prepared in a production scale continuous casting machine, as described by Hellsund in U.S. Pat. No. 3,371,383 and Opel in U.S. Pat. No. 3,376,371. The contents of both patents are incorporated herein in their entirety by reference as the Inventors' preferred method of making continuous cast sheets.

During a commercial production run to produce solid-surface type sheets of Acrystone® granite Everest in 0.140 inch (0.36 cm) thickness, an aliquot of the liquid dispersion was removed containing a mixture of syrup, methyl methacrylate, aluminum tri-hydrate, colored particles (prepared as described in Comparative Example 8) and all other ingredients necessary to complete the polymerization. Five phr of tabular alumina AC-99, −100 mesh in particle size were added under agitation to this aliquot. To distinguish this specific formulation from the one of the same color produced before and after it in the continuous casting machine, a very small amount (0.1 phr) of carbon black pigment paste was also added. A grey-looking sheet was obtained from this specific formulation whereas the standard granite Everest sheets are an off-white color. Sheet samples from the standard Acrystone® Everest sheet produced just before the one with tabular alumina added were subjected to testing and the results are listed in Table I as Comparative Example 11. The gray sheet samples of the Everest containing the tabular alumina and the black pigment were subjected to testing and the results are listed in Table I as Example 12.

### Comparative Example 13 and Example 14

The procedure of Comparative Example 11 was used to produce sheet samples of 0.515 inch (1.31 cm) thickness with a continuous casting process and equipment. During a production run to make solid-surface sheets of Acrystone® granite colors, a batch of granite Twilight color had 5 phr of −100 mesh tabular alumina added to it. When the polymerized sheets exited the casting machine, samples were taken and subjected to testing. The results are given in Table I as Example 14. Standard sheets of Acrystone® Everest (i.e., without the addition of tabular alumina) from the batch produced before that modified to produce Example 14 were taken and subjected to testing. The results for those standard sheets are given in Table I as Comparative Example 13.

### Comparative Example 15

Fifty parts of aluminum tri-hydrate (OE-100, Huber Corp.), were added under agitation to 50 parts of unsaturated polyester laminating resin COREZYN (COR 63-AA-261, Interplastic Corp.). Wetting agents, release agents and catalyst (MEK peroxide) were also added under agitation. After degassing, the mixture filled the space between two cell casting plates. Following the procedures known to those skilled in the art, the cell cast assembly was postcured at 250° F. (121.1° C.) for 30 minutes. After cooling to room temperature and disassembly, a 0.5 inch (1.27 cm) thick sheet was obtained. This sheet was subjected to testing.

### EXAMPLE 16

The procedure of Comparative Example was used to prepare a sheet sample, wherein 10 parts of the OE-100 were replaced by 10 parts of −100 mesh, tabular alumina.

### EXAMPLE 17

A solid surface type sheet of uniform color was prepared as in Comparative Example 1 except that 60% of the syrup was replaced by tabular alumina (−325 mesh, AC-012). The alumina was added under moderate agitation after the other ingredients. The mixture was degassed and polymerized to obtain a glossy, white sheet of 0.5 in (1.27 cm) thickness.

Sheet Preparation and Testing

Sheets prepared in Comparative Example 1, Example 2, Comparative Example 3, Example 4, Comparative Example 15 and Example 16 were tested on the bottom surface as obtained after the cells were opened and the steel plates removed. Sheets made in the other examples had about 15 mm removed from the bottom side surface by multiple passes under a drum sander using 80 grit coarse sandpaper as the abrading medium. The coarse finish was then sanded with finer and finer grit sandpapers (120, 180, 220 and 320 grit) and finally with a wet, grey Scotch Brite® abrasive pad (manufactured by the 3M Corp.) for 15 sec. This sanding and finishing procedure is commonly performed on solid-surface sheet with a granite pattern, to remove the top layer to a depth at which the color and appearance will not change as further thickness is removed. Because this is done to the sheets before they are installed in their application, the Inventors have included it in their sample preparation.

TABLE 1

| | 50 Strokes Steel Wool Test | | Weight Loss Test | |
|---|---|---|---|---|
| | (percent gloss at 60°) | | (grams) | |
| Example | Before | After 50 strokes | After 15 min. | After 60 min. |

| | | | | |
|---|---|---|---|---|
| Comp. | 124.9⁽⁺⁾ | 37.2 | 9.97 | 35.8(*) |
| Ex. 1 | | | | |
| 2 | 88.1 | 87.4 | 0.06 | 0.11 |
| Comp. | 88.7 | 25.8 | 10.81 | 40.0 |
| Ex. 3 | | | | |
| 4 | 87.5 | 87.1 | 0.11 | 0.16 |
| Comp. | 87.4 | 54.0 | 21.3 | (*) |
| Ex. 5 | | | | |
| 6 | 88.0 | 87.8 | 1.50 | 2.6 |
| 7 | 86.6 | 77.3 | 4.94 | 9.7 |
| Comp. | 86.0 | 60.6 | 18.34 | 63.0(*) |
| Ex. 8 | | | | |
| 9 | 85.7 | 86.1 | 0.04 | 0.15 |
| 10 | 87.1 | 83.7 | 0.14 | 0.28 |
| Comp. | 85.0 | 32.5 | 14.55 | 54.5 |
| Ex. 11 | | | | |
| 12 | 83.8 | 68.1 | 0.07 | 0.16 |
| Comp. | 85.6 | 38.6 | 15.77 | 60.6 |
| Ex. 13 | | | | |
| 14 | 85.9 | 82.1 | 0.06 | 0.17 |
| Comp. | 81.3 | 65.7 | 25.1 | 111.0 |
| Ex. 15 | | | | |
| 16 | 78.6 | 67.9 | 0.04 | 0.10 |
| 17 | 87.5 | 87.9 | 0.06 | Not measured |

(*)Sanding disk wore through the thickness of the sample.
⁽⁺)The gloss reading of 124.9% of sample #1 is a normal value for clear and transparent sheets, because the incident light is reflected back by both surfaces of the sample tested.

Comments on Test Results

As can be seen by reference to Table I, the results of Example 1 and 2 show how the wear resistance of clear and colored plastic sheets is greatly increased by the present invention. The results of the other examples demonstrate how significantly the wear resistance of mineral-filled sheets can be increased by the present invention. All the sheets produced in the Comparative Examples had a much lower value of gloss after the 50 Strokes Test than the corresponding wear resistant sheets (i.e., the sheet including tabular alumina therein). An observer could easily see a much larger number of scratches (also deeper) in those sheets made in the comparative examples than in the wear resistant sheets.

The foregoing illustrations of embodiments of the present invention are offered for the purposes of illustration and not limitation. It will be readily apparent to those skilled in the art that the embodiments described herein may be modified or revised in various ways without departing from the spirit and scope of the invention. The scope of the invention is to be measured by the appended claims.

We claim:

1. A composition comprising a plastic having dispersed therein about 1 phr to about 70 phr of tabular alumina particles.

2. The composition of claim 1, wherein said plastic is selected from the group consisting of polymethyl methacrylate, polyester, polycarbonate, polyethylene, polyvinylchloride, acrylonitrile-butadiene-styrene, polystyrene and polybutylene terephthalate.

3. The composition of claim 1, further including about 1% to about 70% of alumina tri-hydrate.

4. The composition of claim 1, wherein said tabular alumina particles are present in about 1 phr to about 10 phr.

5. The composition of claim 1, wherein said tabular alumina particles are present in about 10 phr to about 70 phr.

6. The composition of claim 1, wherein said tabular alumina particles are less than about 150 microns in size.

7. The composition of claim 1, wherein said tabular alumina particles are about 6 mesh to less than about 60 mesh in size.

8. The composition of claim 1, wherein said tabular alumina particles are about 28 mesh to less than about 60 mesh in size.

9. The composition of claim 1, wherein said tabular alumina particles are less than about 60 mesh in size.

10. A method of making plastic, said method comprising:
combining about 1 phr to about 70 phr of tabular alumina particles with a plastic resin; and
polymerizing said resin to make a plastic having improved abrasion resistance.

11. The method of claim 10, wherein said plastic is selected from the group consisting of polymethyl methacrylate, polyester, polycarbonate, polyethylene, polyvinylchloride, acrylonitrile-butadiene-styrene, polystyrene and polybutylene terephthalate.

12. The method of claim 10, wherein said plastic is polymethyl methacrylate.

13. The method of claim 10, wherein said tabular alumina particles are present in about 1 phr to about 10 phr.

14. The method of claim 10, wherein said tabular alumina particles are present in about 10 phr to about 70 phr.

15. The method of claim 10, wherein said tabular alumina particles are less than about 150 microns in size.

16. The method of claim 10, wherein said tabular alumina particles are about 6 mesh to less than about 60 mesh in size.

17. The method of claim 10, wherein said tabular alumina particles are about 28 mesh to less than about 60 mesh in size.

18. The method of claim 10, wherein said tabular alumina particles are less than about 60 mesh in size.

19. The method of claim 10, wherein said step of forming is selected from thermoforming, extruding, cell casting, continuous casting, injection molding, pultruding and calendering.

20. The method of claim 14, wherein said step of forming comprises thermoforming.

21. A composition comprising polymethyl methacrylate having dispersed therein about 1 phr to about 70 phr of tabular alumina particles.

22. The composition of claim 21, wherein said tabular alumina particles are present in about 1 phr to about 10 phr.

23 The composition of claim 21, wherein said tabular alumina particles are present in about 10 phr to about 70 phr.

24. The composition of claim 21, wherein said tabular alumina particles are less than about 150 microns in size.

25. The composition of claim 21, wherein said tabular alumina particles are about 6 mesh to less than about 60 mesh in size.

26. The composition of claim 21, wherein said tabular alumina particles are about 28 mesh to less than about 60 mesh in size.

27. The composition of claim 21, wherein said tabular alumina particles are less than about 60 mesh in size.

28. The composition of claim 21, further including about 1% to about 70% of aluminum tri-hydrate.

29. A method of making an article, said method comprising:
combining a syrup comprising 10-35% polymethyl methacrylate polymer in methyl methacrylate monomer with about 1 phr to about 70 phr tabular alumina;
polymerizing said syrup; and
forming said polymerized syrup into said article, having improved abrasion resistance.

30. The method of claim 29, wherein said tabular alumina particles are present in about 1 phr to about 10 phr.

31. The method of claim 29, wherein said tabular alumina particles are present in about 10 phr to about 70 phr.

32. The method of claim 29, wherein said tabular alumina particles are less than about 150 microns in size.

33. The method of claim 29, wherein said tabular alumina particles are about 6 mesh to less than about 60 mesh in size.

34. The method of claim 29, wherein said tabular alumina particles are about 28 mesh to less than about 60 mesh in size.

35. The method of claim 29, wherein said tabular alumina particles are less than about 60 mesh in size.

36. The method of claim 29, wherein said step of forming is selected from thermoforming, extruding, cell casting, continuous casting, injection molding, pultruding and calendering.

37. The method of claim 29, wherein said step of forming comprises thermoforming
